(19) United States
(12) Patent Application Publication
(10) Pub. No.: US 2020/0086819 A1
(43) Pub. Date: Mar. 19, 2020

(54) FASTENER FOR A ROOF RAIL AIR BAG IN A VEHICLE AND A ROOF RAIL AIRBAG ASSEMBLY INCLUDING THE FASTENER

(71) Applicant: GM GLOBAL TECHNOLOGY OPERATIONS LLC, DETROIT, MI (US)

(72) Inventors: Patrick Landis, Washington, MI (US); Kenneth M. Zawisa, Farmington Hills, MI (US)

(21) Appl. No.: 16/133,986

(22) Filed: Sep. 18, 2018

(51) Int. Cl. B60R 21/213

(52) U.S. Cl. CPC B60R 21/213; B60R 21/232

(57) ABSTRACT

A roof rail airbag assembly for a vehicle includes a roof rail in a vehicle frame, a roof rail airbag including a main airbag body and an airbag retaining tab extending from the main airbag body, a roof rail airbag fastener capturing the airbag retaining tab between the fastener and the roof rail, and a bolt extending through the roof rail airbag fastener, through the airbag retaining tab and extending into the roof rail. The roof rail airbag fastener includes a bolt passthrough opening and a separating tab extending from an inwardly facing surface of the fastener and positioned between the bolt passthrough opening and the main airbag body.

### FIELD

The present disclosure relates to a fastener for a roof rail air bag and a roof rail airbag assembly including the fastener.

### INTRODUCTION

This introduction generally presents the context of the disclosure. Work of the presently named inventors, to the extent it is described in this introduction, as well as aspects of the description that may not otherwise qualify as prior art at the time of filing, are neither expressly nor impliedly admitted as prior art against this disclosure.

Use of roof rail air bag assemblies, used primarily to protect vehicle passengers is well known. Likewise, methods of attaching these air bag assemblies are also well known. Despite the widespread use of these air bag assemblies, and despite the many different means by which they are attached to the interior of a roof rail of a vehicle, typical attachment mechanisms have a number of inherent limitations.

FIG. 1 is a perspective view of an interior of a frame 100 in a vehicle in which an air bag 102 has been installed to the roof rail 104 of the frame and FIG. 2 illustrates the air bag 102 in isolation. A plurality of cushion retaining tabs 106 extend along the length of the air bag 102. Though not shown in FIGS. 1 and 2, each of the retaining tabs 106 is attached to a fastening clip which retains a bolt which is used to fix the air bag 102 to the roof rail 104.

FIGS. 3 and 4 provide perspective views of a conventional roof rail airbag fastening clip 300 attached to a retaining tab 302 of an airbag 304. The fastening clip 300 is formed from an assembly of three components: a retaining plate 306, a roof rail hanger 308, and a push pin 310. Prior to fastening to the roof rail 104, the air bag 304 is provided with the fastening clip 300 assembled to the retaining tab 302. The roof rail hanger 308 includes tabs 312 which project through the retaining tab 302 and the retaining plate 306. The tabs 312 are folded over with a push press which secures the retaining tab 302 between the retaining plate 306 and the roof rail hanger 308. Next, the push pin 310 is positioned on one side of the roof rail hanger 308 and a bolt 314 is extended through the retaining plate 306, the roof rail hanger 308 and is held by the push pin 310 by an interference fit between the push pin 310 and the bolt 314. In this configuration, the air bag is provided to the roof rail 104 of the vehicle frame 100 by an installation technician.

An installation technician positions the air bag 304 with the fastening clip 300 to the roof rail 104 such that hooks 316 of the hanger 308 extend through corresponding holes 318 in the sheet metal of the roof rail 104. In this manner, the air bag 304, together with the fastening clip 300, hangs from the roof rail 104 in a position where the air bag 304 is ready to be subsequently permanently attached to the roof rail 104. In a subsequent assembly step, the air bag 304 is secured to the roof rail 104 by threadably fastening the bolt 314 into an internally threaded weld nut 320 on the roof rail 104.

The conventional roof rail air bag fastening clip 300 suffers from a number of problems. Between the assembly step of hanging the air bag 304 from the roof rail 104 and the subsequent step of securely fastening the bolt 314 to the roof rail 104 the hooks 316 of the roof rail hanger 308 may easily become dislodged. This conventional fastening clip 300 relies solely upon gravity to retain the air bag 304 in position on the roof rail 104 and any movement may result in one or more hooks 316 becoming dislodged. A fastening clip for a roof rail air bag which solves this and other problems is needed.

### SUMMARY

In an exemplary aspect, a roof rail airbag assembly for a vehicle includes a roof rail in a vehicle frame, a roof rail airbag including a main airbag body and an airbag retaining tab extending from the main airbag body, a roof rail airbag fastener capturing the airbag retaining tab between the fastener and the roof rail, and a bolt extending through the roof rail airbag fastener, through the airbag retaining tab and extending into the roof rail. The roof rail airbag fastener includes a bolt passthrough opening and a separating tab extending from an inwardly facing surface of the fastener and positioned between the bolt passthrough opening and the main airbag body.

In this manner, the space occupied by the roof rail airbag assembly may be significantly reduced while simultaneously reducing the risk of damaging the airbag during assembly and simplifying the roof rail airbag installation process.

In another exemplary aspect, the separating tab forms an arcuate shape.

In another exemplary aspect, the main airbag body is in contact with the separating lip.

In another exemplary aspect, the bolt passthrough opening includes a plurality of bolt retaining tabs.

In another exemplary aspect, the bolt retaining tabs provide an interference fit with a shaft of the bolt.

In another exemplary aspect, the roof rail airbag fastener further includes a first arm and a second arm extending from an outwardly facing surface of the fastener through the airbag retaining tab and into corresponding openings in the roof rail.

In another exemplary aspect, the first and second arms are elastically biased away from each other such that they each maintain contact with the openings in the roof rail.

In another exemplary aspect, at least one of the first and second arms includes a barb extending from a surface of the corresponding arm.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the present invention are readily apparent from the detailed description, including the claims, and exemplary embodiments when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view of an interior of a frame in a vehicle in which an air bag has been installed to the roof rail of the frame;

FIG. 2 is an illustration of an exemplary air bag module and inflator bracket in isolation;

FIG. 3 is a perspective view of a conventional roof rail airbag fastening clip;

FIG. 4 is another perspective view of the conventional roof rail airbag fastening clip of FIG. 3;

FIG. 5 is a perspective view of the roof rail airbag fastening clip installed into a vehicle frame roof rail;

FIG. 6 is a perspective view of a roof rail airbag fastening clip in accordance with an exemplary embodiment of the present disclosure;

FIG. 7 is a close-up perspective view of the roof rail airbag fastening clip of FIG. 6 in a fully installed configuration;

FIG. 8 is a perspective view of the roof rail airbag fastening clip of FIG. 6 in an intermediate installation configuration;

FIG. 9 is another perspective view of the roof rail airbag fastening clip of FIG. 6 in an intermediate installation configuration;

FIG. 10 is a perspective view of the roof rail airbag fastening clip of FIG. 6 in a fully installed configuration where the airbag is not shown for clarity; and

FIG. 11 is another perspective view of the roof rail airbag fastening clip of FIG. 6 in a fully installed configuration.

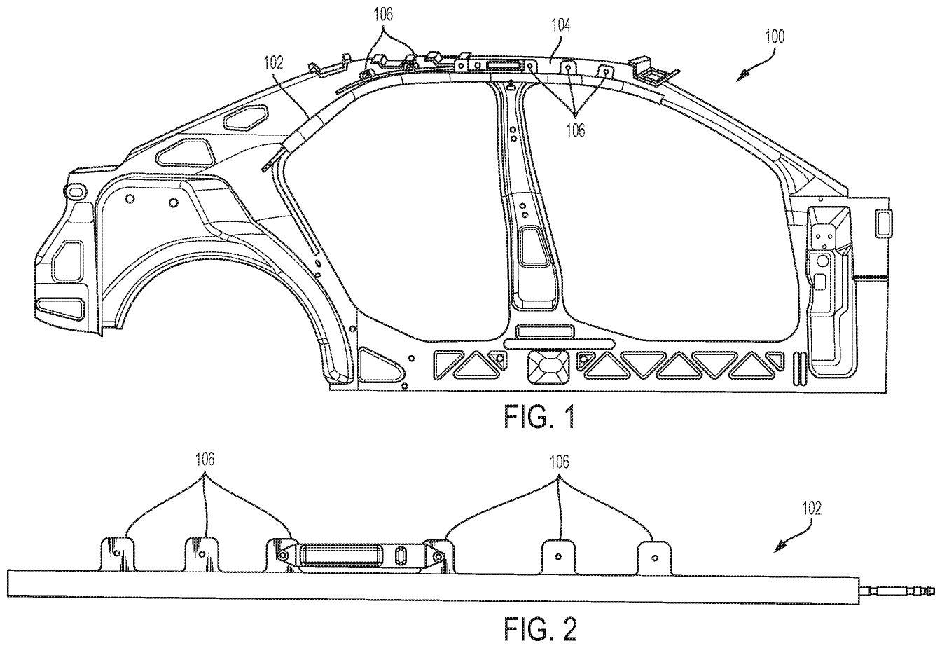

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, over, above, below, beneath, rear, and front, may be used with respect to the drawings. These and similar directional terms are not to be construed to limit the scope of the disclosure in any manner. Referring now to the drawings, wherein like reference numbers correspond to like or similar components throughout the several figures.

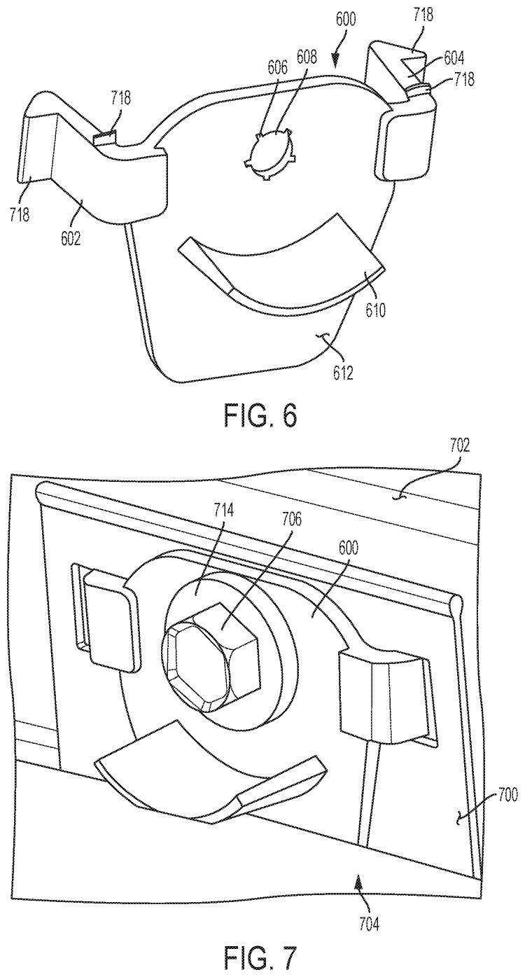

FIG. 6 is a perspective view of a roof rail airbag fastening clip 600 in accordance with an exemplary embodiment of the present disclosure. The fastening clip 600 includes first and second arms, 602 and 604, a bolt passthrough 606 which includes bolt retaining tabs 608, and a separation lip 610. The first and second arms, 602 and 604, are configured to pass through corresponding holes in a vehicle roof rail. In a preferred embodiment, the first and second arms 602 and 604 are elastically biased in a manner which securely holds the fastening clip 600 to the roof rail when the arms, 602 and 604, extend into the roof rail. The bolt passthrough 606 is configured to receive a bolt (not shown) where the bolt retaining tabs 608 provide an interference fit with the bolt to securely retain the bolt in position in the bolt passthrough 606. The separating lip 610 extends from an inwardly facing surface 612 of the fastening clip 600. The fastening clip 600 integrates multiple functions into a single part by including the arms, 602 and 604, the bolt passthrough 606 with retaining tabs 608, and the separating lip 610.

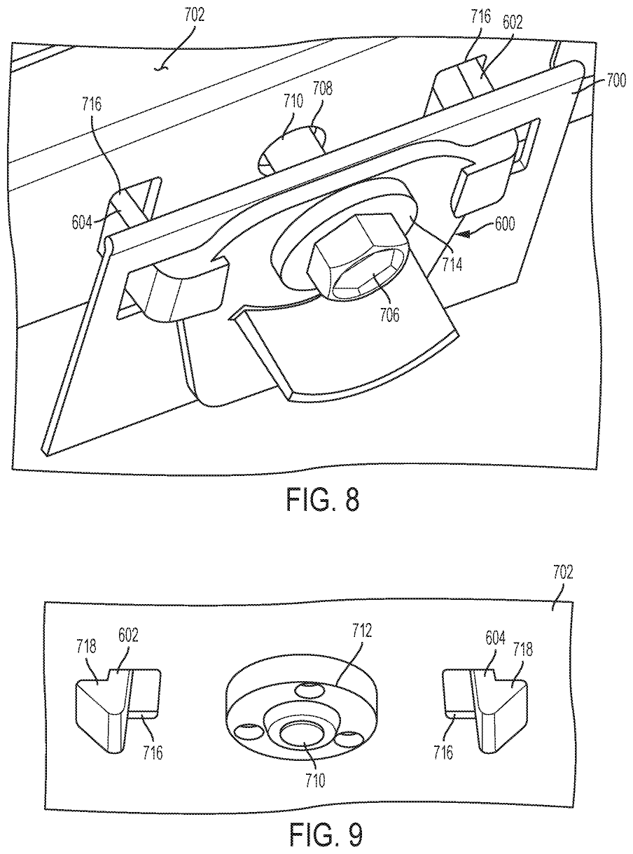

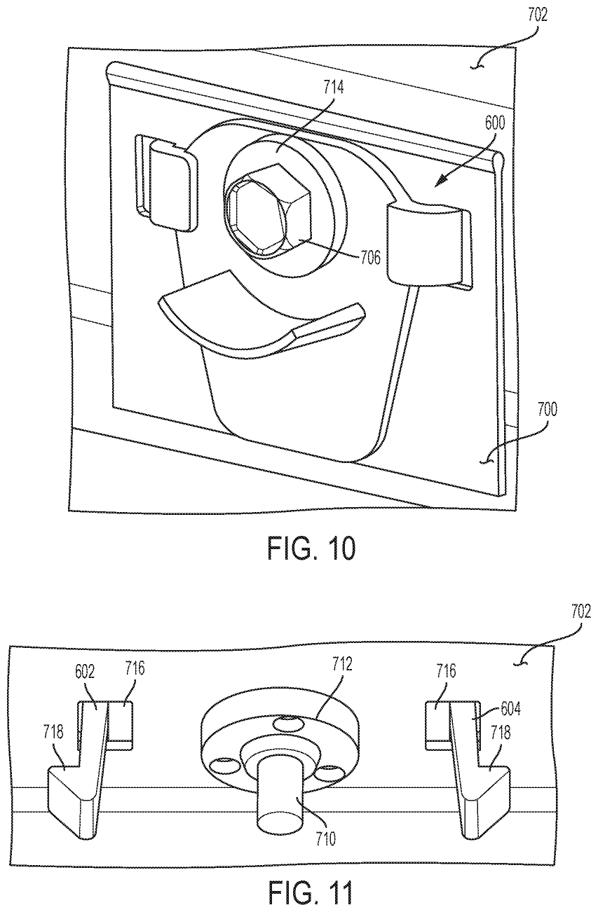

Installation of the fastening clip 600 will now be described with reference to FIGS. 7-11. The fastening clip 600 is illustrated in its fully installed configuration in FIGS. 7 and 10-11. The fastening clip 600 is installed in a configuration where the airbag retaining tab 700 is firmly secured between the fastening clip 600 and the roof rail 702. The retaining tab 700 extends from the main body 704 of the air bag. The main body 704 is not illustrated in FIGS. 8-11 for purposes of clarity. A bolt head 706 of a bolt extends through the bolt passthrough 606 of the fastening clip 600 and a bolt receiving opening 708 in the roof rail 702. FIG. 9 illustrates that a threaded shaft 710 of the bolt further extends into an internally threaded weld nut 712 in the intermediate configuration and is firmly threadably secured into the weld nut 712 in the fully installed configuration illustrated in FIGS. 10 and 11. The configuration illustrated in FIGS. 7-8 and 8, includes an optional washer 714.

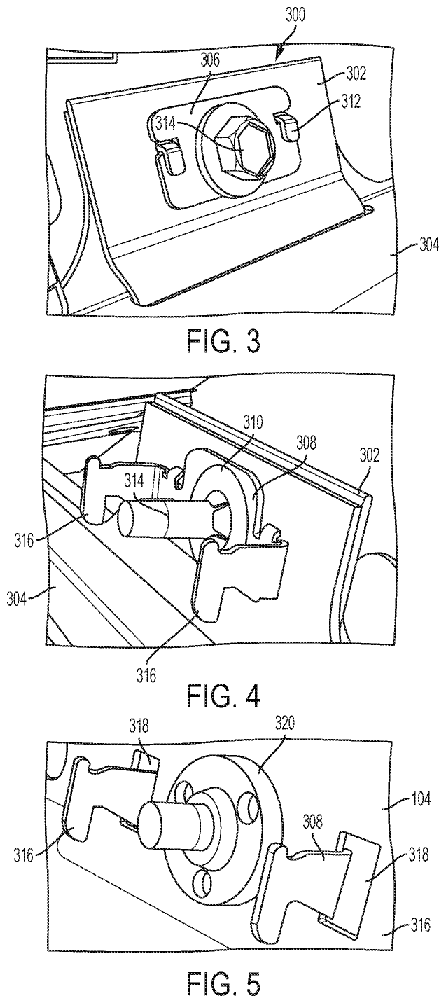

In stark contrast to conventional roof rail airbag fasteners, an exemplary embodiment of which is illustrated in FIGS. 3-5, the fastener 600 of the present disclosure provides not only all of the functions of the conventional roof rail airbag fasteners in a single component, thereby significantly reducing cost and simplifying assembly, but also incorporates a separation lip 610 which provides an additional function which has not previously been available. A problem which the conventional roof rail airbag fasteners have suffered is ensuring enough clearance between the body of the airbag and the bolt head. During installation, the body of the airbag is compliant and may move upward close to the bolt head and/or cover at least a portion of the bolt head. When this happens, the installation technician who uses a bolt head driver to secure the bolt to the roof rail must move the airbag body away from the bolt head and keep it away during the driving of the bolt to prevent damage to the airbag. To reduce the risk of the airbag body encroaching upon the bolt head and/or at least partially concealing the bolt head, the airbag retaining tab is configured to have a length which is sufficient to keep the airbag body away from the bolt head. Increasing the length of the airbag retaining tab undesirably increases the amount of space required for the entire roof rail airbag assembly. In contrast, the inventive roof rail airbag fastener 600 of the present disclosure includes a separation lip 610 which ensures separation between the airbag 704 and the bolt head 706 as clearly illustrated in FIG. 7. In this manner, the length of the airbag retaining tab 700 may be significantly reduced in comparison to conventional roof rail airbag installations which markedly reduces the amount of space occupied by the inventive roof rail airbag installation through use of the fastener 600 of the present disclosure. Indeed, the length of the retaining tab 700 may be reduced such that the main body of the airbag 704 contacts the separating lip 610 without risking intrusion of the airbag into the space required to operate the bolt driver to drive the bolt and threadably secure the roof rail airbag to the roof rail.

Optionally, the separating lip 610 may form an arcuate shape which may thereby conform to the external shape of the bolt driver and further act as a bolt driver guide and/or support to assist an installation technician in guiding the bolt driver to the bolt head and maintaining the position of the bolt driver on the bolt head while driving the bolt head into the fully seated and fully threadably installed configuration.

As is illustrated in FIGS. 8-9, in the intermediate installation configuration, the first and second arms, 602 and 604, extend into openings 716 of the roof rail 702. The arms 602 and 604 are elastically biased outwardly such that the fastener 600 securely holds the airbag in position while in the intermediate installation configuration. In this manner, the airbag may be temporarily and reliably held in position adjacent the roof rail until a subsequent installation step of threadably driving the bolt into the final, fully installed configuration.

Additionally, and optionally, the arms, 602 and 604, may each include one or more barbs 718 laterally extending from the arm(s) to assist in ensuring the arms, 602 and 604, maintain their intermediate installation configuration and do not exit from the roof rail openings 716 between when the fastener 600 is positioned in the intermediate installation configuration (as shown in FIG. 9) and the full installation configuration (as shown in FIG. 11).

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A roof rail airbag assembly for a vehicle, the assembly comprising:
a roof rail in a vehicle frame;
a roof rail airbag including a main airbag body and an airbag retaining tab extending from the main airbag body;
a roof rail airbag fastener capturing the airbag retaining tab between the fastener and the roof rail; and
a bolt extending through the roof rail airbag fastener, through the airbag retaining tab and extending into the roof rail, wherein the roof rail airbag fastener comprises a bolt passthrough opening and a separating tab extending from an inwardly facing surface of the fastener and positioned between the bolt passthrough opening and the main airbag body.

2. The assembly of claim 1, wherein the separating tab forms an arcuate shape.

3. The assembly of claim 1, wherein the main airbag body is in contact with the separating lip.

4. The assembly of claim 1, wherein the bolt passthrough opening comprises a plurality of bolt retaining tabs.

5. The assembly of claim 4, wherein the bolt retaining tabs provide an interference fit with a shaft of the bolt.

6. The assembly of claim 1, wherein the roof rail airbag fastener further comprises a first arm and a second arm extending from an outwardly facing surface of the fastener through the airbag retaining tab and into corresponding openings in the roof rail.

7. The assembly of claim 6, wherein the first and second arms are elastically biased away from each other such that they each maintain contact with the openings in the roof rail.

8. The assembly of claim 6, wherein at least one of the first and second arms comprise a barb extending from a surface of the corresponding arm.

9. A roof rail airbag fastener for a roof rail airbag for a vehicle, the fastener comprising:
a bolt passthrough opening configured to receive a shaft of a bolt; and
a separating tab extending between an inwardly facing surface of the fastener and positioned adjacent the bolt passthrough opening.

10. The fastener of claim 9, wherein the separating tab forms an arcuate shape.

11. The fastener of claim 9, wherein the separating tab is positioned between the bolt passthrough opening and an area on the inwardly facing surface adapted to receive a main body of a roof rail airbag.

12. The fastener of claim 9, wherein the bolt passthrough opening comprises a plurality of bolt retaining tabs.

13. The fastener of claim 12, wherein the bolt retaining tabs provide an interference fit with a shaft of the bolt.

14. The fastener of claim 9, further comprising a first arm and a second arm extending from an outwardly facing surface of the fastener through the airbag retaining tab and into corresponding openings in the roof rail.

15. The fastener of claim 14, wherein the first and second arms are elastically biased away from each other such that they each maintain contact with the openings in the roof rail.

16. The fastener of claim 14, wherein at least one of the first and second arms comprise a barb extending from a surface of the corresponding arm.
